(19) United States
(12) Patent Application Publication
(10) Pub. No.: US 2022/0134697 A1
(43) Pub. Date: May 5, 2022

(54) TIRE VULCANIZATION DEVICE AND METHOD

(71) Applicant: The Yokohama Rubber Co., LTD., Tokyo (JP)

(72) Inventor: Yukihisa TAKAHASHI, Kanagawa (JP)

(21) Appl. No.: 17/310,658

(22) PCT Filed: Dec. 2, 2019
(86) PCT No.: PCT/JP2019/047015

§ 371 Date: Aug. 16, 2021

(30) Foreign Application Priority Data
Feb. 22, 2019 (JP) 2019-030007

(51) Int. Cl. B29D 30/06

(52) U.S. Cl. CPC B29D 30/0606

(57) ABSTRACT

In a mold of a tire vulcanization device, a sensor is installed in a state exposed on a tire molding surface, a connector is installed in a state exposed on an attachment surface, the sensor and the connector are connected by a lead wire extending through an interior of the mold. In container components, an inner connector is installed in a state exposed on an opposing surface, and a lead wire connected to the inner connector is extended through an interior of the container components toward an exterior of the container components.

### TECHNICAL FIELD

The present technology relates to a tire vulcanization device and method and particularly relates to a tire vulcanization device and a vulcanization method that are capable of accurately ascertaining the state of a tire in a vulcanization step and that have excellent wiring workability.

### BACKGROUND ART

When manufacturing a tire, a green tire is vulcanized in a vulcanization mold installed in a vulcanization container. When manufacturing a tire that satisfies a reference quality, the green tire needs to be vulcanized under appropriate predetermined conditions (for example, temperature or pressure). The temperature of the tire during vulcanization is ascertained, for example, by detecting the temperature of steam injected into the vulcanization mold or a vulcanization bladder. Additionally, the pressure acting on the tire during vulcanization is ascertained by, for example, detecting the pressure of the steam injected into the vulcanization bladder. Thus, in a method that indirectly detects the temperature or pressure of a tire rather than detecting the actual temperature or pressure, it is difficult to accurately ascertain the pressure acting on the tire and the actual tire temperature during vulcanization, and the state of the tire during vulcanization cannot be accurately ascertained.

In order to directly detect the temperature of the tire during vulcanization, a known vulcanization device has a temperature sensor embedded in a vulcanization mold and brings the temperature sensor into proximity with a tire in the vulcanization mold (see Japan Unexamined Patent Publication No. 2010-284863). In a vulcanization device having such a structure, a lead wire connected to a temperature sensor must be wired to a vulcanization mold or a vulcanization container so as not to break during opening and closing of the vulcanization mold. Moreover, there is room for improving the workability of such a vulcanization device because a complicated operation of wiring the lead wire to the vulcanization mold or the vulcanization container is required each time the vulcanization mold is replaced.

### SUMMARY

The present technology provides a tire vulcanization device and a vulcanization method that are capable of accurately ascertaining the state of a tire in a vulcanization step and that have excellent wiring workability.

A tire vulcanization device of the present technology includes a vulcanization mold and a vulcanization container in which the vulcanization mold is installed, the vulcanization device including: a sensor installed at a predetermined position on the vulcanization mold in a state exposed on a tire molding surface of the vulcanization mold; a mold-side connector installed in the vulcanization mold in a state exposed on an attachment surface of the vulcanization mold that attaches to a container component constituting the vulcanization container; an in-mold lead wire extending through an interior of the vulcanization mold and connecting the sensor and the mold-side connector; an inner connector installed in the container component in a state exposed on an opposing surface of the container component facing the attachment surface; and an in-container lead wire connected at one end portion to the inner connector and extending through an interior of the container component toward an exterior of the container component, the mold-side connector and the inner connector being freely connected to and disconnected from each other.

A tire vulcanization method of the present technology includes installing a vulcanization mold in a vulcanization container, disposing a green tire in the vulcanization mold while the vulcanization mold is open, and closing the vulcanization mold and vulcanizing the green tire, the method including: in the vulcanization mold, installing a sensor at a predetermined position in a state exposed on a tire molding surface, installing a mold-side connector in a state exposed on an attachment surface that attaches to a container component constituting the vulcanization container, and connecting the sensor and the mold-side connector with an in-mold lead wire extending through an interior of the vulcanization mold; in the container component, installing an inner connector in a state exposed on an opposing surface facing the attachment surface, and extending an in-container lead wire through an interior of the container component toward an exterior of the container component, the in-container lead wire being connected at one end portion to the inner connector; and connecting the mold-side connector and the inner connector when installing the vulcanization mold in the vulcanization container, acquiring detection data from the sensor during vulcanization of the green tire, the detection data being acquired outside the vulcanization container through the in-mold lead wire and the in-container lead wire, and disconnecting the mold-side connector and the inner connector when the vulcanization mold is removed from the vulcanization container.

According to the present technology, when installing the vulcanization mold in the vulcanization container, connecting the mold-side connector and the inner connector connects the in-mold lead wire and the in-container lead wire to the sensor. This allows the lead wire connected to the sensor to be pulled out of the container component. When removing the vulcanization mold from the vulcanization container, disconnecting the mold-side connector and the inner connector separates the in-mold lead wire and the in-container lead wire. Accordingly, the mold can be removed without disturbing the lead wire connected to the sensor. In addition, each of the in-mold lead wire and the in-container lead wire moves with and follows the vulcanization mold and the container component in which they are routed. In this way, the lead wires can be appropriately wired without complicated wiring work, and the lead wires can be connected to and separated from the sensor, providing excellent wiring workability. During vulcanization of the tire, detection data detected by the sensor directly contacting the tire can be acquired outside the vulcanization container through the in-mold lead wire and the in-container lead wire. Thus, the state of the tire during vulcanization can be accurately ascertained based on the detection data.

### BRIEF DESCRIPTION OF DRAWINGS

FIG. 1 is an explanatory diagram illustrating the right half of a tire vulcanization device of an embodiment of the present technology in a vertical cross-sectional view.

FIG. 2 is an explanatory diagram illustrating a state in which a top plate, container ring, and segment of FIG. 1 are moved downward and a vulcanization mold is closed.

FIG. 3 is an explanatory diagram illustrating the container ring, top plate, and a sector mold of FIG. 2 in a plan view.

FIGS. 4A-4B illustrate connectors that are to be connected to each other. FIG. 4A is an explanatory diagram illustrating the connectors disconnected from each other and FIG. 4B is an explanatory diagram illustrating the connectors connected to each other.

FIG. 5 is an explanatory diagram illustrating the vulcanization mold of FIG. 2 in a closed state.

FIG. 6 is an explanatory diagram illustrating the container ring, top plate, and sector mold of FIG. 5 in a plan view.

### DETAILED DESCRIPTION

Hereinafter, a tire vulcanization device and method of the present technology will be described based on the embodiment illustrated in the figure.

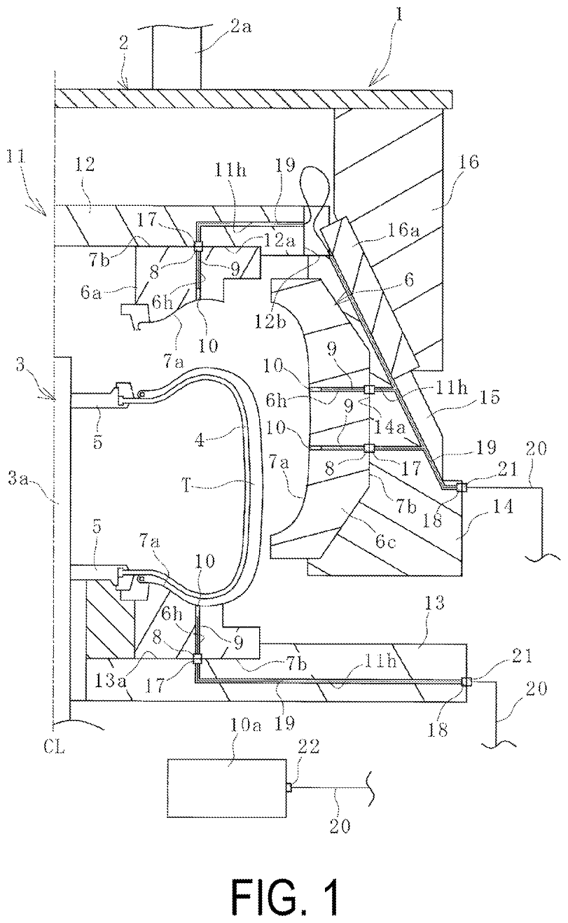

A tire vulcanization device 1 in an embodiment of the present technology illustrated in FIGS. 1 to 3 (hereinafter referred to as a vulcanization device 1) includes a center mechanism 3, a vertically moving plate portion 2 that moves vertically above the center mechanism 3, a vulcanization mold 6 (hereinafter referred to as a mold 6), and a vulcanization container 11 (hereinafter, referred to as a container 11). Furthermore, the vulcanization device 1 includes a sensor 10, a mold-side connector 8 (hereinafter referred to as a connector 8), an in-mold lead wire 9 (hereinafter referred to as a lead wire 9) that connects the sensor 10 and the connector 8, an inner connector 17, and an in-container lead wire 19 (hereinafter referred to as a lead wire 19) connected to the inner connector 17.

The sensor 10 allows the vulcanization device 1 to detect data necessary to ascertain the state of a green tire T during vulcanization. In this embodiment, a sensor 10 is used that detects the temperature of the green tire T during vulcanization or the pressure acting on the green tire T. Other examples of the sensor 10 include hardness sensors that detect the hardness of the green tire T during vulcanization.

This embodiment further includes an outer connector 18 that is connected to the inner connector 17 via the lead wire 19. An output connector 21 that is connected to a first end portion of an external lead wire 20 is connected to the outer connector 18. An input connector 22 that is connected to a second end portion of the external lead wire 20 is connected to a measurement instrument 10a disposed outside the vulcanization device 1.

A hydraulic cylinder 2a, for example, moves the vertically moving plate portion 2 up and down. Disc-shaped clamp portions 5 are attached at intervals in the vertical direction to a center post 3a constituting the center mechanism 3. Upper and lower end portions of a cylindrical vulcanization bladder 4 are gripped by the respective clamp portions 5.

When vulcanizing the green tire T, the container 11 is installed surrounding the center mechanism 3. A mold 6 is installed in the container 11. When a different type of tire is to be vulcanized, the mold 6 that has been installed in the container 11 up to that point is replaced with a mold 6 corresponding to the next tire to be vulcanized.

The container 11 includes a top plate 12, a bottom plate 13, a plurality of segments 14, and a container ring 16 serving as container components. The container ring 16 is attached to the vertically moving plate portion 2 by bolts, for example.

A sectional mold 6 is installed in the container 11. The mold 6 includes an annular upper side mold 6a, an annular lower side mold 6b, and a plurality of sector molds 6c having an arcuate shape in a plan view.

An upper surface 7b (hereinafter, an attachment surface 7b) of the upper side mold 6a is attached facing a lower surface 12a (hereinafter, an opposing surface 12a) of the top plate 12. The top plate 12 moves vertically together with the upper side mold 6a, independently of the vertically moving plate portion 2 (container ring 16), using a drive means not illustrated in the drawings. The lower surface 7b (hereinafter, an attachment surface 7b) of the lower side mold 6b is attached facing an upper surface 13a (hereinafter, an opposing surface 13a) of the bottom plate 13. The bottom plate 13 is fixed to a ground base in an immovable state. An outer circumferential surface 7b (hereinafter, an attachment surface 7b) of a sector mold 6c is attached to each of the segments 14 so as to face an inner circumferential surface 14a (hereinafter, an opposing surface 14a) thereof.

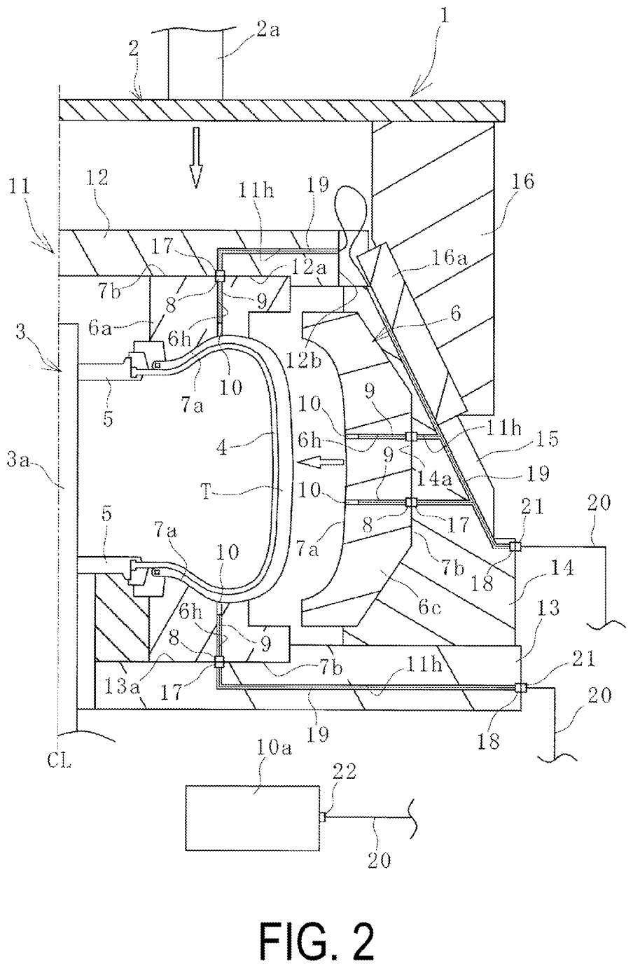

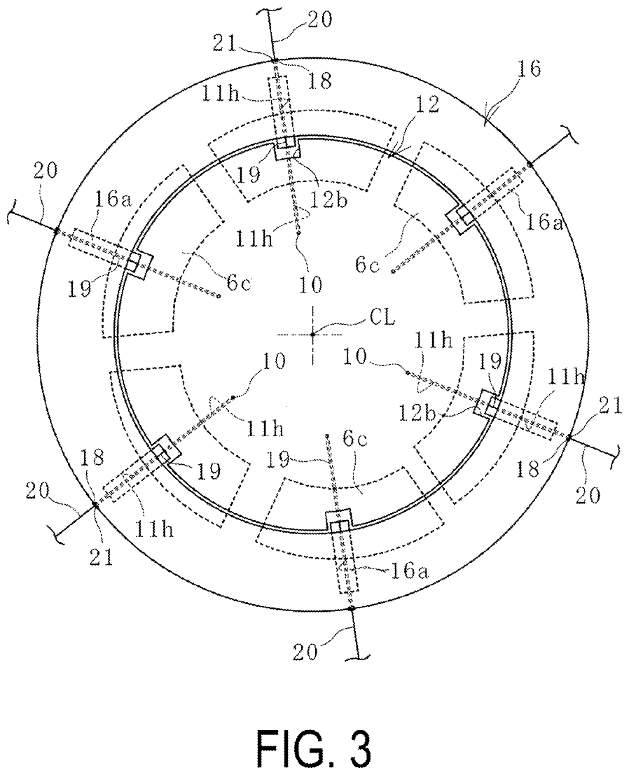

The sector molds 6c (segments 14) are arranged in an annular shape around the center mechanism 3. In other words, as illustrated in FIG. 3, each sector mold 6c (segment 14) is arranged in an annular shape in a plan view, and the annular center of the sector molds 6c is indicated by a dot-dash line CL. The center mechanism 3 (center post 3a) is disposed in the annular center CL. The annular center CL is the annular center of the upper side mold 6a and the lower side mold 6b. Although the right half of the vulcanization device 1 is illustrated in FIGS. 1 and 2, the left half has substantially the same structure as the right half.

The outer circumferential surface of each segment 14 inclines, from up to down, toward an outer circumference. Guide grooves 15 extend in the vertical direction along the outer circumferential inclined surface of each segment 14.

The cylindrical container ring 16 is arranged centered about the center mechanism 3 (the annular center CL) and moves vertically on the outer circumference side of the segments 14. An inner circumferential surface of the container ring 16 inclines, from up to down, toward the outer circumference. The inner circumferential inclined surface of the container ring 16 and the outer circumferential inclined surface of each of the segments 14 are arranged facing each other.

A plurality of guide keys 16a are disposed at intervals in the circumferential direction on the inner circumferential inclined surface of the container ring 16. These guide keys 16a extend in the vertical direction along the inner circumferential inclined surface of the container ring 16. Each guide key 16a is engaged with a corresponding guide groove 15, and the guide key 16a (inner circumferential inclined surface of the container ring 16) and the guide groove 15 (outer circumferential inclined surface of each segment 14) slide. In this embodiment, each segment 14 is configured to be suspended from the container ring 16 by a guide key 16a that engages with a guide groove 15.

As illustrated in FIG. 3, a plurality of notches 12b are formed at intervals in the circumferential direction on an outer circumferential surface of the top plate 12. The notch 12b is continuous from the upper surface to the lower surface of the top plate 12. The notches 12b each correspond to a respective guide key 16a and are formed so as to prevent interference between the guide key 16a and the top plate 12.

The sensor 10 is installed at a predetermined position on the mold 6 in a state exposed on a tire molding surface 7a of the mold 6. In this embodiment, a predetermined position at which the sensor 10 is installed is set at a plurality of positions (six locations) spaced apart in a tire circumferential direction in each region on the tire molding surface 7a where a tire tread surface and both side surfaces (right side surface and left side surface) are molded. For example, in each region, the sensor 10 is disposed at two to six positions at equal intervals in the tire circumferential direction.

A through-hole 6h extending through the mold 6 is formed at a predetermined position on the mold 6, and the sensor 10 is embedded in the through-hole 6h. The connector 8 is installed in the through-hole 6h in a state exposed on the attachment surface 7b of the mold 6 that attaches to the container components 12, 13, 14. That is, the through-hole 6h is formed in the top plate 12, the bottom plate 13, and the segments 14. The lead wire 9 extends through the through-hole 6h to connect the sensor 10 and the connector 8.

The inner connector 17 is installed in the container components 12, 13, 14 in a state exposed on the opposing surfaces 12a, 13a, 14a of the container components 12, 13, 14 that face the attachment surfaces 7b. Through-holes 11h extending through the container components 12, 13, 14 are formed in the container components 12, 13, 14 and the inner connector 17 is installed in the through-holes 11h. The outer connector 18 is installed in the through-hole 11h in a state exposed on the outside of the container components 13, 14. The lead wire 19 extends into the through-hole 11h and connects the inner connector 17 and the outer connector 18. In FIGS. 1 to 3, the connector 8 and the inner connector 17 are connected.

The lead wire 19 communicates with the through-hole 11h of the segment 14 from the through-hole 11h of the top plate 12, but the lead wire 19 is exposed to the outside between the two through-holes 11h. When the mold 6 is opened and closed, the segment 14 slides horizontally relative to the top plate 12. So that the lead wire 19 does not become taut and sever accompanying this sliding of the segment 14, there is surplus length in the lead wire 19 which is exposed to the outside between the through-hole 11h of the top plate 12 and the through-hole 11h of the segment 14. Note that the through-hole 11h formed along the outer circumferential inclined surface of the segment 14 may also have a groove shape, rather than being a complete hole.

The external lead wire 20 connecting the output connector 21 and the input connector 22 extends outside the container 11. The outer connector 18 and the output connector 21 are connected to each other, and the input connector 22 and the measurement instrument 10a are connected to each other.

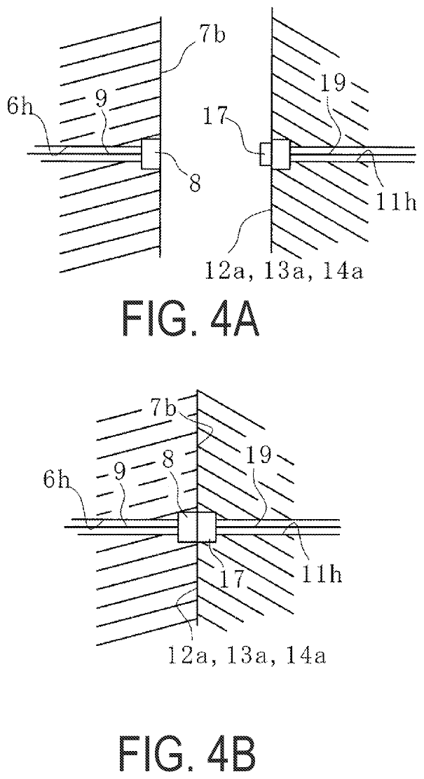

As illustrated in FIG. 4A, the connector 8 and the inner connector 17 are separate components and are independent of each other. The connector 8 and the inner connector 17 in the disconnected state can be connected to each other as illustrated in FIG. 4B. In other words, the connector 8 and the inner connector 17 are freely connected to and disconnected from each other. Each of the connectors 8, 17 may employ a known structure. Similarly, the outer connector 18 and the output connector 21 are freely connected to and disconnected from each other, and the input connector 22 and the measurement instrument 10a are freely connected to and disconnected from each other.

Next, a procedure for vulcanizing the green tire T using this vulcanization device 1 will be described.

When vulcanizing the green tire T, the mold 6 is installed in the container 11. At this time, each of the connectors 8 and the corresponding inner connectors 17 are connected. Moreover, each of the outer connectors 18 and the corresponding output connectors 21 are connected. Thus, the sensor 10 and the measurement instrument 10a are connected through the lead wires 9, 19, 20.

Next, the container 11 to which the mold 6 is attached is installed surrounding the center mechanism 3. Thereafter, each of the outer connectors 18 and the corresponding output connectors 21 may be connected. Next, as illustrated in FIG. 1, the green tire T is disposed inside the widely opened mold 6. The green tire T is disposed on the lower side mold 6b in a sideways manner.

Next, the upper side mold 6a is moved downward together with the top plate 12 that is in an upper standby position, and the container ring 16 and each of the segments 14 are moved downward together with the vertically moving plate portion 2. Accordingly, as illustrated in FIG. 2, each segment 14 is placed on the upper surface of the bottom plate 13 and each of the segments 14 are interposed to be vertically between the top plate 12 and the bottom plate 13. In this state, as illustrated in FIG. 3, each of the segments 14 (sector molds 6c) is disposed at a position that expands in diameter in a plan view.

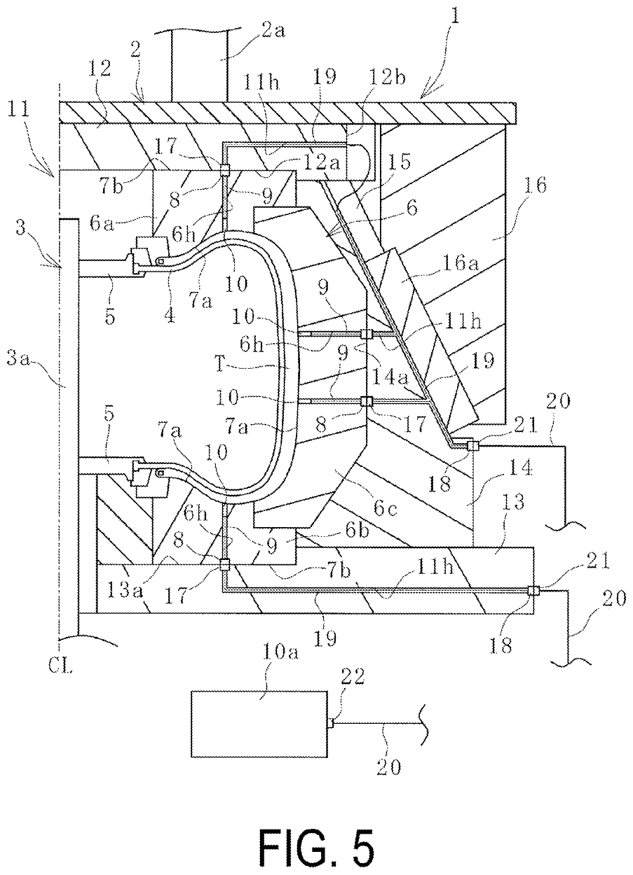

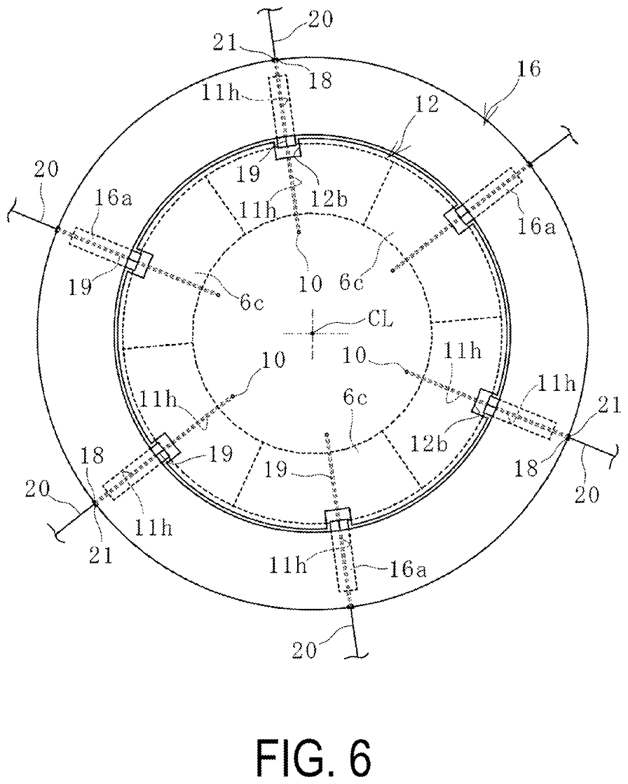

Next, the container ring 16 together with the vertically moving plate portion 2 is moved further downward from the state illustrated in FIG. 2. Accordingly, the guide key 16a moves downward along the guide groove 15, and the outer circumferential inclined surface of each segment 14 is pressed by the inner circumferential inclined surface of the downward-moving container ring 16. As a result, as illustrated in FIGS. 5 and 6, each sector mold 6c moves close to the annular center CL, the sector molds 6c are assembled in an annular shape, and the mold 6 is closed.

In the closed mold 6, the vulcanization bladder 4 is inflated inside the green tire T and applies a predetermined pressure to the green tire T, and together with this the green tire T is heated at a predetermined temperature and vulcanized. During vulcanization of the green tire T, each sensor 10 directly contacts the green tire T and detects predetermined data (temperature data, pressure data) indicating the state of the green tire T. The detection data from each sensor 10 is input to and acquired by the measurement instrument 10a through the lead wires 9, 19, 20. Accordingly, the predetermined data indicating the state of the green tire T can be ascertained in real time.

When a predetermined vulcanization time elapses, vulcanization of the green tire T is completed and the tire is finished. After vulcanization, the mold 6 is opened and the finished tire is removed from the vulcanization device 1. The mold 6 is used to sequentially vulcanize the required number of green tires T. When vulcanizing each of the green tires T, the detection data from each of the sensors 10 is acquired in a similar manner.

After the required number of tires have been vulcanized using the mold 6, the mold 6 is removed from the container 11 for replacement with another mold 6. When removing the mold 6 from the container 11, the connection between the connector 8 and the inner connector 17 is released. Furthermore, the connection between the outer connector 18 and the output connector 21 is released.

As described above, when installing the mold 6 in the container 11, the sensor 10 and the lead wires 9, 19 are connected by connecting the connector 8 and the inner connector 17. In this connecting operation, the lead wires 9, 19 that are connected to the sensors 10 are pulled out of the container components 12, 13, 14 and the installation of necessary wiring is completed. When removing the mold 6 from the container 11, the lead wires 9, 19 are separated by disconnecting the connector 8 and the inner connector 17 from each other. Therefore, the mold 6 can be removed without disturbing the lead wires 9, 19. The lead wires 9, 19 that are wired to the moving container components 12, 14 each move together with the moving mold 6 and container components 12, 14 and therefore are not disturbed.

In this way, the lead wires 9, 19 can be appropriately wired without complicated wiring work and the lead wires 9, 19 can be connected to and disconnected from a sensor 10. In other words, wiring workability to perform the wiring necessary to directly detect the state of the green tire T during vulcanization using the sensor 10 is excellent.

Because there is no need to perform complicated wiring work in order to acquire detection data from the sensor 10 each time the mold 6 is replaced, it is possible to avoid increasing the time required for the work of switching out the mold 6. Accordingly, negative effects on tire production capacity can be avoided.

The detection data from the sensor 10 is predetermined data detected by direct contact with the green tire T. Therefore, in comparison to data detected indirectly without contacting the green tire T, the state of the green tire T during vulcanization can be more accurately ascertained by analyzing the green tire T based on the detection data from the sensor 10.

An embodiment of the present technology can be applied to a mass production line for tires. Therefore, the state (for example, temperature state, pressure state) of the green tire T in a vulcanization step can be ascertained for each of the tires being mass-produced, which greatly contributes to quality control of the produced tire.

The second end portion of the lead wire 19 can also be connected to the measurement instrument 10a by extending outside of the container components 13, 14 without connecting to the outer connector 18. In other words, the outer connector 18 can also be omitted, but providing the outer connector 18 allows a state in which the lead wire 19 extends in an uninterrupted length outside the container components 13, 14 to be avoided and when the mold 6 is replaced, for example, the lead wire 19 does not interfere and workability is improved.

When the predetermined position at which the sensor 10 is installed is set at a plurality of positions spaced apart in the tire circumferential direction in each region on the tire molding surface 7a where the tire tread surface and both side surfaces (right side surface and left side surface) are molded, as in this embodiment, variations in the state of the green tire T in the circumferential direction during vulcanization can be accurately ascertained. The installation position of the sensor 10 may be set as necessary and, therefore, there may be cases using only one region or cases using only two regions from among the regions on the tire molding surface 7a where the tire tread surface (corresponds to the sector mold 6c) and both side surfaces (correspond to the upper side mold 6a and lower side mold 6b) are molded.

Additionally, the sensor 10 can also be installed at a plurality of predetermined positions spaced apart in a tire width direction in a region on the tire molding surface 7a where the tire tread surface is molded. Moreover, the sensor 10 can also be installed at a plurality of predetermined positions spaced apart in a tire radial direction in a region on the tire molding surface 7a where both side surfaces are molded.

An embodiment of the present technology is not limited to a sectional mold 6 and can also be applied to a two-part mold constituted by an upper mold and a lower mold disposed vertically opposite each other.

1. A tire vulcanization device comprising a vulcanization mold and a vulcanization container in which the vulcanization mold is installed, the vulcanization device comprising:
a sensor installed at a predetermined position on the vulcanization mold in a state exposed on a tire molding surface of the vulcanization mold;
a mold-side connector installed in the vulcanization mold in a state exposed on an attachment surface of the vulcanization mold that attaches to a container component constituting the vulcanization container;
an in-mold lead wire extending through an interior of the vulcanization mold and connecting the sensor and the mold-side connector;
an inner connector installed in the container component in a state exposed on an opposing surface of the container component facing the attachment surface; and,
an in-container lead wire connected at one end portion to the inner connector and extending through an interior of the container component toward an exterior of the container component,
the mold-side connector and the inner connector being freely connected to and disconnected from each other.

2. The tire vulcanization device according to claim 1, further comprising an outer connector connected to an other end portion of the in-container lead wire and installed on the container component in a state exposed on an outer side of the container component.

3. The tire vulcanization device according to claim 1, wherein the predetermined position is set at a plurality of positions spaced apart in a tire circumferential direction in each region on the tire molding surface where a tire tread surface and both side surfaces are molded.

4. The tire vulcanization device according to claim 1, wherein the sensor is at least one of a temperature sensor or a pressure sensor.

5. A tire vulcanization method comprising installing a vulcanization mold in a vulcanization container, disposing a green tire in the vulcanization mold while the vulcanization mold is open, and closing the vulcanization mold and vulcanizing the green tire, the method comprising:
in the vulcanization mold, installing a sensor at a predetermined position in a state exposed on a tire molding surface, installing a mold-side connector in a state exposed on an attachment surface that attaches to a container component constituting the vulcanization container, and connecting the sensor and the mold-side connector with an in-mold lead wire extending through an interior of the vulcanization mold;
in the container component, installing an inner connector in a state exposed on an opposing surface facing the attachment surface, and extending an in-container lead wire through an interior of the container component toward an exterior of the container component, the in-container lead wire being connected at one end portion to the inner connector; and,
connecting the mold-side connector and the inner connector when installing the vulcanization mold in the vulcanization container, acquiring detection data from the sensor during vulcanization of the green tire, the detection data being acquired outside the vulcanization container through the in-mold lead wire and the in-container lead wire, and disconnecting the mold-side connector and the inner connector when the vulcanization mold is removed from the vulcanization container.

6. The tire vulcanization device according to claim 2, wherein the predetermined position is set at a plurality of positions spaced apart in a tire circumferential direction in each region on the tire molding surface where a tire tread surface and both side surfaces are molded.

7. The tire vulcanization device according to claim 6, wherein the sensor is at least one of a temperature sensor or a pressure sensor.
